(19) United States
(12) Patent Application Publication
(10) Pub. No.: US 2014/0006918 A1
(43) Pub. Date: Jan. 2, 2014

(54) METHOD AND SYSTEM FOR WEB PAGE REARRANGEMENT

(71) Applicants: Dian Fan, Beijing (CN); Xuanran Wang, Beijing (CN); Dongjie Qi, Beijing (CN); Feng Hong, Beijing (CN); Heng Qu, Beijing (CN); Jiangji Huang, Beijing (CN)

(72) Inventors: Dian Fan, Beijing (CN); Xuanran Wang, Beijing (CN); Dongjie Qi, Beijing (CN); Feng Hong, Beijing (CN); Heng Qu, Beijing (CN); Jiangji Huang, Beijing (CN)

(73) Assignee: XIAOMI INC., Haidian District, Beijing (CN)

(21) Appl. No.: 14/005,010

(22) PCT Filed: Mar. 13, 2012
(86) PCT No.: PCT/CN2012/072281

§ 371 Date: Sep. 13, 2013

(30) Foreign Application Priority Data
Mar. 14, 2011 (CN) 201110060341.4

(51) Int. Cl. G06F 17/22

(52) U.S. Cl. CPC G06F 17/2288
USPC 715/229

(57) ABSTRACT

Disclosed is a method and system for web page rearrangement, suitable for mobile phone Internet. A mobile phone browser client obtains a web page address and queries a cache server to determine whether a previously rearranged version of the page has been stored under the web address. If no previously rearranged version of the page has been stored, the mobile phone browser client obtains the non-rearranged version of the web page and uses a preset web page rearrangement strategy to produce a rearranged version of the non-rearranged version of the web page corresponding to the web page address. Said rearranged page corresponding to the web page address is uploaded and saved to the cache server.

### FIELD OF ART

The present disclosure relates to mobile phone Internet technology, and more particularly to a method and system for web page rearrangement.

### BACKGROUND

In the field of computer-based Internet, web cache servers are widely deployed to accelerate Internet browsing and a broad range of cache server products are available, such as products offered by SQUID and NGINX. As the main strategy, these cache servers store the most frequently accessed web content (e.g., pictures and static web pages) in a high-speed cache to accelerate user browsing. However, since such technology is not required to transform any original WWW web page, there is a very poor experience of accessing WWW web pages via mobile phones with a relatively small screen.

In the field of mobile Internet browsing, an example of server cache acceleration technology is developed by UCWEB (UCWEB browser). According to its operating principle, the server's computing capability is used to capture WWW web pages for subsequent web page rearrangement. Given the hundreds of billions of Chinese web pages, this model consumes extensive computing capability and network bandwidth for the servers. In addition, web crawlers are not welcome by some websites. For this kind of website, it is difficult to repeatedly capture the web pages via a proxy server. At the same time, this may cause waste of server resources, since a large fraction of the web pages are not actually accessed by mobile phone users.

### SUMMARY

The purpose of the present disclosure is to provide a method and system for web page rearrangement, which could maintain the cache servers' acceleration effect and also significantly reduce the consumption of server resources.

To this end, the present disclosure adopts the following technical scheme:

A method for web page rearrangement for mobile phone Internet browsing, comprising:
A. Mobile phone browser client obtains a web address.
B. Mobile phone browser client queries a cache server whether a previously rearranged version of the web page for the web address has been stored. The cache server determines whether the rearranged version of the page has been stored. If yes, the cache server sends the rearranged version of the page to the mobile phone browser client, and the mobile phone browser client displays the rearranged version of the web page. Otherwise, go to step C.
C. Mobile phone browser client obtains non-rearranged version of the web page from the web address.
D. Mobile phone browser client uses a preset web page rearrangement strategy to generate a rearranged version of the non-rearranged version of the web page corresponding to the web address. The mobile phone browser client displays the rearranged version of the web page.
E. Mobile phone browser client uploads the rearranged version of the web page corresponding to the web address, to the cache server for storing.

The preset web page rearrangement strategy includes extracting content, executing web scripts, and removing ads.

The preset web page rearrangement strategy is stored in the mobile phone browser client.

The cache server periodically sweeps expired web page caches.

A system for rearranging web pages for mobile phone Internet browsing, which includes a mobile phone browser client and a cache server. The mobile phone browser client and the cache server are connected via a network. The mobile phone browser client is used to obtain and display rearranged versions of web pages corresponding to web addresses. According to a web page rearrangement strategy, rearranged versions of the web pages are generated from non-rearranged versions of the web pages and are uploaded to the cache server. The cache server is used to store the rearranged versions of the web pages corresponding to the web addresses. The cache server sends the rearranged versions of the web pages to the mobile phone browser client.

The technical scheme of the present disclosure maintains the acceleration from web cache servers. At the same time, the task of rearranging web pages (e.g., executing Javascript, utilizing Cascading Style Sheets (CSS) templates, downloading flash and uploading ads pictures, etc.), which consumes computing resources and network bandwidth, is distributed to various mobile phone terminal devices and performed as needed. This greatly reduces the consumption of server resources, especially for websites hosting news, blogs, and serial stories where content does not change much.

### BRIEF DESCRIPTION OF THE FIGURES

FIG. 1 is a flowchart illustrating the process of rearranging web page according to a preferred embodiment.

### DETAILED DESCRIPTION OF EMBODIMENTS

Preferred embodiments of the present disclosure are further described herein with reference to the accompanying FIGURE.

According to the main concept of the technical scheme of the present disclosure, a system suitable for rearranging web pages for mobile phone Internet browsing is provided. The system maintains the acceleration effect of cache servers. Also, as needed, the system distributes to mobile phone devices the task of rearranging web pages, which consumes computer resources and network bandwidth.

The system includes a mobile phone browser client and a cache server. The mobile phone browser client and the cache server are connected via a network. The mobile phone browser client obtains and displays a rearranged version of a web page corresponding to a web address. Based on a preset web page rearrangement strategy, the rearranged version of the web page is generated from a non-rearranged version of the web page and uploaded to the cache server. The cache server stores the rearranged version of the web page corresponding to the web address and serves the rearranged version to mobile phone browser clients.

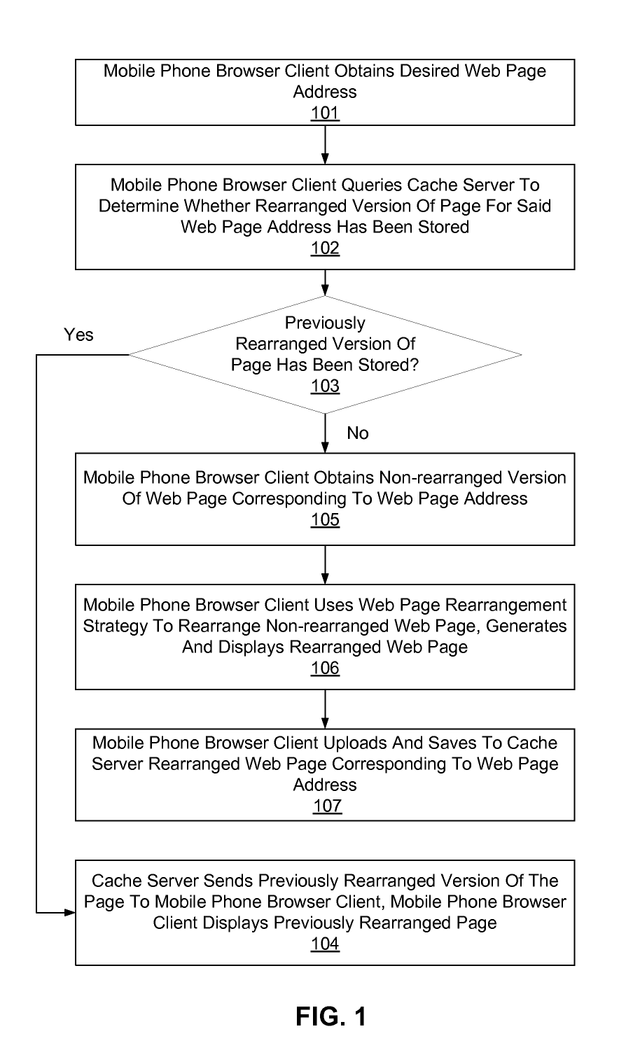

FIG. 1 is a flowchart illustrating the process of rearranging web page according to a preferred embodiment. As shown in FIG. 1, the web page rearranging process includes:

Step 101. The mobile phone browser client obtains a web address to be accessed.

Step 102. The mobile phone browser client queries if a cache server has stored a rearranged version of the page corresponding to the web address.

Step 103. The cache server determines if a rearranged version of the web page has been stored. If yes, the process continues to step 104. Otherwise, the process goes to step 105.

Step 104. The cache server sends the rearranged version of the web page to the mobile phone browser client. The mobile phone browser client then displays the rearranged version of the web page.

Step 105. The mobile phone browser client obtains a non-rearranged version of the web page from the web address.

Step 106. The mobile phone browser client applies a preset web page rearrangement strategy to the non-rearranged version of the web page, generates a rearranged version of the web page corresponding to the web address, and displays the rearranged version of the web page. The preset web page rearrangement strategy is stored in the mobile phone browser client. The preset web page rearrangement strategy includes extracting content, executing web script and removing ads, etc.

Step 107. The mobile phone browser client uploads to the cache server the rearranged version of the web page corresponding to the web address.

The cache server periodically sweeps the expired web page caches. The expiration policy at the cache server can be set according to the Hypertext Transfer Protocol (HTTP) standard 1.1 (e.g., IETF RFC 2616). The expiration policy can also be set depending on individual websites.

The cache server can identify the screen size, mobile phone model, network environment of mobile clients, etc. The cache server can also conduct multistage caching based on different parameter settings. For security reasons, the cache server does not cache web pages to which users have logged on, so as to avoid disclosure of the users' private information.

In addition, the cache server can actively or passively push new preset web page rearrangement policies to mobile phone browser clients.

Tests have shown that average web page loading time can be reduced from 25 s to 5 s after implementing the system in a General Packet Radio Service (GPRS) mobile network. In a WIFI environment, web pages can be opened almost instantly. In one example, the size of a web page from a Sina news website was reduced from 900 KB to less than 100 KB after rearranging the web page, demonstrating an obvious data reduction effect by web page rearrangement.

The above is a detailed description of the technical features of the present disclosure based on a preferred embodiment. However, it should be appreciated that the present disclosure is capable of a variety of embodiments and various modifications by those skilled in the art, and all such variations or changes shall be embraced within the scope of the following claims.

1. A method for web page rearrangement for mobile phone Internet browsing, the method comprising a mobile phone browser client performing the steps of:
obtaining a web address for a web page to be displayed on the mobile phone;
querying whether a cache server has stored a rearranged version of the web page, the rearranged version suitable for display on the mobile phone.
if the cache server has a rearranged version of the web page in storage, then receiving the rearranged version of the web page from the cache server; and
if the cache server does not have a rearranged version of the web page in storage, then:
obtaining a non-rearranged version of the web page from the web address;
using a preset web page rearrangement strategy to generate a rearranged version from the non-rearranged version, the rearranged version suitable for display on the mobile phone; and
uploading the rearranged version of the web page to the cache server for storing.

2. The method of claim 1, wherein the preset web page rearrangement strategy includes extracting content.

3. The method of claim 1, wherein the preset web page rearrangement strategy is stored in the mobile phone browser client.

4. The method of claim 1, wherein the cache server periodically sweeps expired web page caches.

5. (canceled)

6. The method of claim 1, wherein the preset web page rearrangement strategy includes executing web scripts.

7. The method of claim 1, wherein the preset web page rearrangement strategy includes removing ads.

8. A method for web page rearrangement for mobile phone Internet browsing, the method comprising a cache server performing the steps of:
receiving, from a mobile phone, a web address for a web page to be displayed on the mobile phone;
determining whether the cache server has a rearranged version of the web page in storage, the rearranged version suitable for display on the mobile phone;
if the cache server has a rearranged version of the web page in storage, then sending to the mobile phone the rearranged version of the web page; and
if the cache server does not have a rearranged version of the web page in storage, then:
receiving from the mobile phone a rearranged version of the web page, the rearranged version generated by the mobile phone from a non-rearranged version using a preset web page rearrangement strategy; and
storing the rearranged version of the web page.

9. The method of claim 8, wherein the cache server further performs the step of:
periodically sweeping expired web page caches.

10. The method of claim 8, wherein the cache server further performs the step of:
providing a new preset web page rearrangement strategy to the mobile phone.

11. The method of claim 8, wherein the cache server further performs the step of:
pushing a new preset web page rearrangement strategy to the mobile phone.

12. The method of claim 8, wherein the cache server further performs the step of:
identifying an attribute of the mobile phone, wherein the rearranged version is suitable for display on the mobile phone with the identified attribute.

13. The method of claim 8, wherein the identified attribute is a screen size of the mobile phone.

14. The method of claim 8, wherein the identified attribute is a model type of the mobile phone.

15. The method of claim 8, wherein the identified attribute is a network environment of the mobile phone.

16. A non-transitory computer-readable storage medium storing executable computer program instructions for web page rearrangement for mobile phone Internet browsing, the computer program instructions comprising instructions for a mobile phone browser client to perform the steps of:
obtaining a web address for a web page to be displayed on the mobile phone;
querying whether a cache server has stored a rearranged version of the web page, the rearranged version suitable for display on the mobile phone;
if the cache server has a rearranged version of the web page in storage, then receiving the rearranged version of the web page from the cache server; and
if the cache server does not have a rearranged version of the web page in storage, then:
obtaining a non-rearranged version of the web page from the web address;
using a preset web page rearrangement strategy to generate a rearranged version from the non-rearranged version, the rearranged version suitable for display on the mobile phone

17. The non-transitory computer-readable storage medium of claim 16, wherein the preset web page rearrangement strategy includes extracting content.

18. The non-transitory computer-readable storage medium of claim 16, wherein the preset web page rearrangement strategy includes executing web scripts.

19. The non-transitory computer-readable storage medium of claim 16, wherein the preset web page rearrangement strategy includes removing ads.

20. The non-transitory computer-readable storage medium of claim 16, wherein the computer program instructions further comprise instructions for the mobile phone browser client to perform the step of:
receiving a new preset web page rearrangement strategy from the cache server.

21. The non-transitory computer-readable storage medium of claim 16, wherein the computer program instructions further comprise instructions for the mobile phone browser client to perform the step of:
uploading the rearranged version of the web page to the cache server for storing.
